(19) United States
(12) Patent Application Publication
(10) Pub. No.: US 2024/0378562 A1
(43) Pub. Date: Nov. 14, 2024

(54) INTELLIGENT SUBSTITUTION IN PROCESS AUTOMATION

(71) Applicant: SAP SE, Walldorf (DE)

(72) Inventor: Prashant Gautam, Bangalore (IN)

(73) Assignee: SAP SE, Walldorf (DE)

(21) Appl. No.: 18/196,871

(22) Filed: May 12, 2023

(51) Int. Cl. G06Q 10/105

(52) U.S. Cl. CPC G06Q 10/105

(57) ABSTRACT

When an out-of-office message is received for an approver of an automated process, steps can be taken to determine a substitute approver so that the process can continue in the absence of the original approver. Various features related to machine learning can be implemented to increase accuracy of the substitute approver determination. Named entity recognition (NER) features can be used, and a knowledge graph representing the out-of-office message can be constructed from raw data. The technologies can be useful for maintaining execution of automated processes in the face of absent approvers.

### FIELD

The field generally relates to automated processes, and particularly for approvals during such processes in cases of a missing approver.

### BACKGROUND

Automated processes have become an integral part of business operations. Such processes can take the form of an automated workflow that can perform many operations automatically, but they may seek human approval at one or more stages of the process. In practice, a message can be sent to the human approver, who decides whether or not to approve a task in the process.

Although such a system generally works well, work can come to a halt in the face of an absent approver. One solution to address the absent approver is to specify rules about who can substitute for the approver when the original approver is absent. However, such an approach is fraught with problems.

First, such rules can be complicated to specify. Second, organizations change rapidly over time, so such rules need to be updated on a regular basis. Thus, the original, primary approvers must maintain such rules, which can become a tedious task requiring continual manual effort. Therefore, the rules are often not maintained, and no approver can be found.

Without an approver, the approval process is slowed down, impacting company operations and eventually revenue.

Therefore, there remains a need for a more robust technology to handle the absent approver problem in automated processes.

### BRIEF DESCRIPTION OF THE DRAWINGS

FIG. 1 is a block diagram of an example system implementing intelligent substitution in process automation.

FIG. 2 is a flowchart of an example method of implementing intelligent substitution in process automation.

FIG. 3 is a block diagram of example out of office messages.

FIG. 4 is a sequence diagram of an example consumption flow for intelligent substitution in process automation.

FIG. 5 is a sequence diagram showing an example training flow for intelligent substitution in process automation.

FIG. 6 is a block diagram of an example architecture for implementing intelligent substitution in process automation.

FIG. 7 is an example user interface for implementing intelligent substitution in process automation.

FIG. 8 is a block diagram of an example knowledge graph representation of an out-of-office message.

FIG. 9 is a block diagram of an example system assembling features for a machine learning model.

FIG. 10 is a block diagram of example conversion from out-of-office message to features for training a machine learning model.

FIGS. 11, 12, and 13 are block diagrams of example details of conversion from out-of-office message to features for training a machine learning model.

FIG. 14 is a block diagram of an example computing system in which described embodiments can be implemented.

FIG. 15 is a block diagram of an example cloud computing environment that can be used in conjunction with the technologies described herein.

### DETAILED DESCRIPTION

### EXAMPLE 1—OVERVIEW

Automated processes can greatly increase productivity of an organization because much of the work is done by computing systems. However, such processes often contain approval steps that specify that approval from a human user is needed to complete a task within the process.

In practice, such a system works well, but problems can arise when the human approver is absent. For example, the human approver may list possible substitutes in an out-of-office message. Thus, the message can be helpful. However, it may contain stale information, or the absent user may forget to specify substitutes.

A rule-based user interface can be provided for specifying substitute rules; however, it can be difficult to maintain rules for an approver who is responsible for many approval processes.

There are other scenarios, such as an unexpected absence, unplanned leave, departure of an employee, or the like, where no helpful information is provided in the out-of-office message.

When no substitute is specified, it can be difficult to find a suitable approver because the primary approver may not be contactable during vacation. The reason for delay may be difficult to determine. Further, it may not be known whom to contact to unblock the approval process, and finally, it may not be possible for any given person to serve as a substitute due to organization policies (e.g., finance, accounting, etc.).

Thus, execution of the automated process stops and cannot be completed because no suitable approver is specified, resulting in costly delays.

As described herein, a machine learning approach can be implemented. A challenge is to provide a seamless, easy-to-activate intelligent substitution without relying on information technology, developers, or end users having to know such details as where the data is collected from, how machine learning is implemented, where it is implemented, when the model is trained, which algorithm is used, and the like. Further, the user should be relieved from having to maintain substitution rules, which can be tedious and burdensome.

As described herein, an out-of-office message can be processed by a machine learning model that predicts a substitute approver based on input features. Such features can include features extracted from the out-of-office message and process metadata, such as an identifier of the original approver and the process definition identifier as described herein.

The described solution can help determine a suitable substitute for the original (primary) approver based on historical data.

Intelligent substitution can be turned on or off at various levels of granularity. Activation granularity can be controlled at a system or individual process level.

Other techniques such as named entity recognition and building a knowledge graph can be implemented as described herein.

Intelligent substitution as described herein reduces the extra effort required by the primary approver to maintain substitution rules during absence while on emergency leave or on vacation, whether planned or unplanned. Intelligent substitution can drastically reduce planned development and maintenance of a rule-based system and the task providers' efforts to enable such an approach.

Instead, the primary approver, in case of an unplanned or planned vacation, simply maintains an automatic out-of-office reply in their mail clients (e.g., Microsoft Outlook or the like). A substitute's contact details in human readable text can be extracted from the out-of-office response. After training, substitutes can be found even if relevant information is not included in the out-of-office reply.

The described technologies thus offer considerable improvements over conventional automated process techniques such as having users maintain substitution rules.

### EXAMPLE 2—EXAMPLE SYSTEM IMPLEMENTING

### Intelligent Substitution in Process Automation

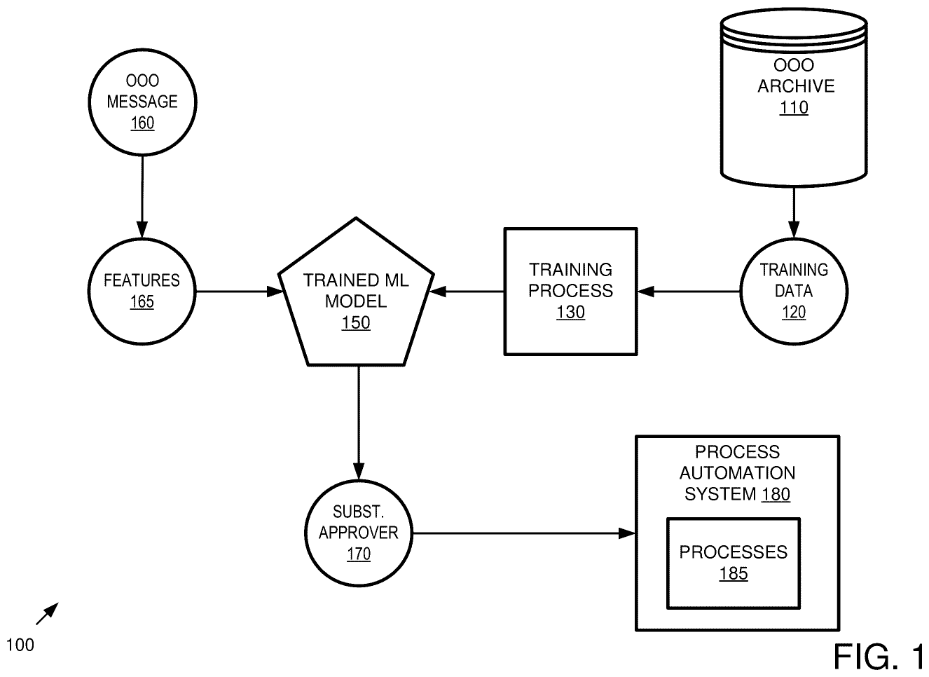

FIG. 1 is a block diagram of an example system 100 implementing intelligent substitution in process automation. In the example, the system 100 comprises a process automation system 180 comprising stored internal representations of automated processes 185 comprising a plurality of tasks. Such representations can comprise process definitions as well as process instances of such definitions. The system 100 can also comprise an out-of-office archive of historical out-of-office messages that can be used to assemble training data 120 that is used by a training process 130 to train a trained machine learning model 150. Thus, the machine learning model can be trained with substitute approvers observed as assigned as substitute approvers for original approvers of the automated processes 185 and be configured to predict one or more substitute approvers for an original approver.

Subsequently, a new out-of-office message 160 can used to generate features 165 that are input to the trained machine learning model 150, which predicts one or more substitute approvers 170 based on the features 165. The substitute approver(s) can then be communicated to the process automation system 180, which can then take appropriate actions as described herein. In practice, features can also be drawn from the process automation system 180 (e.g., automated process instance metadata such as the original approver, automated process definition identifier, and the like).

Any of the systems herein, including the system 100, can comprise at least one hardware processor and at least one memory coupled to the at least one hardware processor.

As described herein, the substitute approvers 170 can be recommended to be assigned as an approver in place of the original approver. In practice, the predicted approvers 170 can include respective confidence scores that help identify those most likely for substitution, likely misassigned substitutes, or the like.

The system 100 can also comprise one or more non-transitory computer-readable media having stored therein computer-executable instructions that, when executed by the computing system, cause the computing system to perform any of the methods described herein.

In practice, the systems shown herein, such as system 100, can vary in complexity, with additional functionality, more complex components, and the like. For example, the training data 120 can include features coming from the process automation system 180 (e.g., an identifier of the original approver, historically assigned substitutes, and the like). There can be additional functionality within the training process. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the out-of-office archive 110, training data 120, trained model 150, automated processes 185, and the like can be stored in one or more computer-readable storage media or computer-readable storage devices. The technologies described herein can be generic to the specifics of operating systems or hardware and can be applied in any variety of environments to take advantage of the described features.

### EXAMPLE 3—EXAMPLE METHOD IMPLEMENTING INTELLIGENT SUBSTITUTION IN PROCESS AUTOMATION

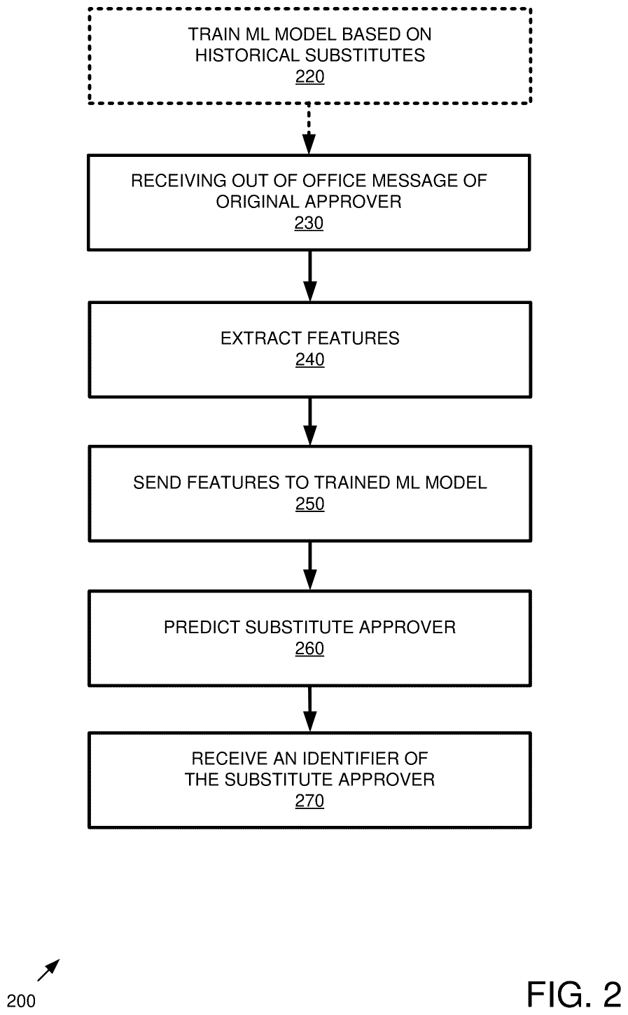

FIG. 2 is a flowchart of an example method 200 of implementing intelligent substitution in process automation and can be performed, for example, by the system of FIG. 1. The automated nature of the method 200 can be used in a variety of situations such as supporting automated process execution, monitoring out-of-office messages during automated processes, or the like.

In the example, at 220, a machine learning model is trained based on historical substitutes. For example, prior out-of-office messages can be analyzed to determine specified substitutes, historical records from a process automation system can be used to determine specified substitutes, or the like. In practice, a party can implement the technologies without performing 220 because the training can be done on the fly in the same system or can be done in advance (e.g., at another location, by another party, or the like). Also, as described herein, the machine learning model can be re-trained continuously or periodically (e.g., after deployment with new historical data).

At 230, an electronic out-of-office message of an original approver (e.g., a message received from an account of the original approver responsive to sending a message to an identifier of the original approver) can be received during execution of an automated process instance specifying the original approver for a task in the automated process. Such an out-of-office message can be received by the automated process administration system, which can orchestrate a response as described below in response to receiving the message.

For example, during execution of an automated process instance, a message can be sent to an email address of a human approver asking for approval of a process task. However, an electronic out-of-office message is received, indicating that the human approver is absent. As described herein, such an out-of-office message may specify substitute approvers.

At 240, features are extracted from the electronic out-of-office message. As described herein, such features can be extracted from the content and metadata of the message, such as the text of the message (e.g., so-called “raw data”). Technologies such as named entity recognition, knowledge graphs, and the like can be applied to extract such features. In addition, features can be obtained from other sources, such as the process automation system, including metadata of the automated process instance. As described herein, such features can comprise an identity of the original approver, a process definition identifier, process type, or the like. Other arrangements are possible.

In practice, information indicating one or more substitutes (e.g., “In my absence, please contact username@domain.com for approvals” or a list of people) can be extracted from text of the out-of-office message.

At 250, features are sent to a machine learning model trained to predict a substitute approver for the original approver. Such features can comprise features extracted from the out-of-office message and metadata of the automated process instance (e.g., an identifier of the original approver).

At 260, with the machine learning model, based on the features (e.g., extracted features, automated process instance metadata, and the like), a substitute approver is predicted for the original approver.

At 270, an identifier of the substitute approver is received. For example, a user identifier or email address of the substitute can be received. In practice, one or more substitutes can be received as described herein.

The identifier can be received by the process automation system, which can then take further steps to orchestrate completion of the process. For example, a message can be sent to the substitute approver regarding the automated process (e.g., seeking approval of the task). Other approaches are possible, such as notifying an Information Technology department, notifying an administrator, the original requestor (of the process) or the like. For example, a message can be sent to an administrator indicating that the substitute approver has been determined and that a seeking-approval message is to be sent to the substitute approver seeking approval of the task in the automated process instance.

Other details, such as confirming permissions or authorization of the substitute can be included. An administrator may assign the approval to a substitute and may need to alter permissions as appropriate. The administrator may take steps such as communicating with plural substitute candidates to find an appropriate one. The technologies can also support assignment to plural substitutes (e.g., the first one who approves becomes the substitute).

In practice, it can be determined whether the substitute approver has permissions to be an approver of the task in the automated process instance. For example, an access control list, lookup table, or other configuration information can be consulted. Responsive to determining that there are permissions, the execution can be permitted to continue. Otherwise, the process can be blocked until a suitable substitute is found or permissions are granted. Permissions determination can be automated depending on organizational policy. In a manual approval scenario, current permissions can be displayed for approval.

A process system (e.g., database, metadata, or the like) can be updated to reflect that the substitute approver can approve (e.g., is authorized to approve) the task of the automated process instance.

Named entity recognition, knowledge graphs, and embeddings can be implemented as described herein.

As described herein, an automated process definition identifier of the automated process instance can be determined, and the machine learning model can predict the substitute approver based on the identifier. A task definition identifier can be used in a similar way as a feature for use with the machine learning model.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, receiving an identifier can be described as sending an identifier depending on perspective.

### EXAMPLE 4—EXAMPLE MACHINE LEARNING MODEL

In any of the examples herein, a machine learning model can be used to generate predictions based on training data. In practice, any number of models can be used. Examples of acceptable models include support vector machines, support vector classifiers, support vector clustering, random decision tree, decision tree (e.g., binary decision tree), random decision forest, Apriori, association rule mining models, and the like. Such models are stored in computer-readable media and are executable with input data to generate an automated prediction.

In practice, training can proceed until a threshold accuracy is observed. Thus, the model can be validated before deployment.

### EXAMPLE 5—EXAMPLE CONFIDENCE SCORE

In any of the examples herein, the trained machine learning model can output a confidence score with any substitute predictions. Such a confidence score can indicate how likely it would be that the particular substitute would be assigned given the input features. Such a confidence score can indicate the relevance of a predicted substitute for a given feature set. The confidence score can be used as a rank to order predictions.

Also, the confidence score can help with filtering. For example, the score can be used to filter out those substitutes with low confidence scores (e.g., failing under a specified low threshold or floor).

Confidence scores can also be used to color code displayed substitutes (e.g., using green, yellow, red to indicate high, medium, or low confidence scores).

### EXAMPLE 6—EXAMPLE PLURAL SUBSTITUTES

In any of the examples herein, if a single possible substitute is predicted, a different action can be taken versus when plural substitutes are predicted. As described herein, filtering can be used to remove possible substitutes below a threshold confidence score.

For example, if a single substitute is predicted, action can be taken to assign the task to the substitute approver and send a mail seeking approval for the process task. Another approach is to obtain confirmation (e.g., send a message for confirmation) from a process administrator, the requesting user, or another party. Then, upon confirmation, the substitute is assigned to continue the approval process.

In the case of more than one substitute, a potential substitute for the specific topic of the process can be found. Confirmation can be sought from the processes administrator or requesting user. Upon confirmation, the selected substitute approver can be assigned to the task and execution of the automated process can continue.

### EXAMPLE 7—EXAMPLE ELECTRONIC OUT-OF-OFFICE MESSAGE

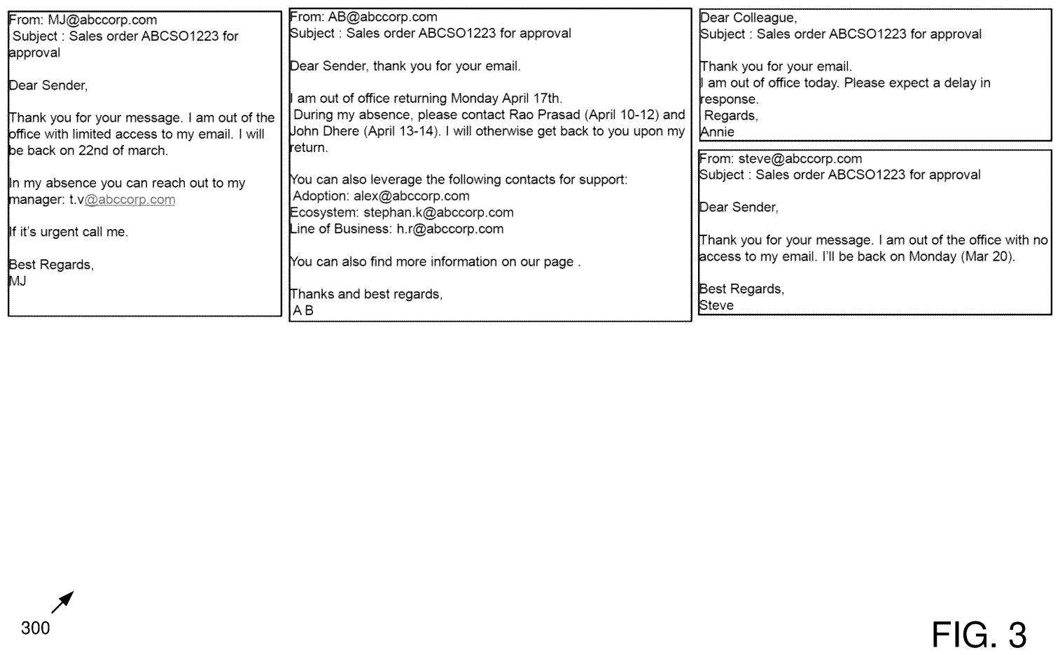

In any of the examples herein, an electronic out-of-office message (or simply “OOO” or “out-of-office message”) can take the form of any electronic message indicating that the person to whom a communication is directed is not available. FIG. 3 is a block diagram of example out of office messages 300.

For example, an automatic email out-of-office message can be sent in response to an email to a user who is not currently available. Such a message is typically set up by the user when they become aware that they are not going to be available. In practice, such a message can leave helpful information about whom to contact in the absence of the intended recipient. As described herein, the out-of-office message of an original approver can be helpful in determining a suitable substitute approver.

Information in such messages can include names, emails, or other identifiers of users who can serve as a substitute approver. In some cases, an image may be helpful (e.g., if OCR is applied to the image).

As shown, such messages can include information about whom can be contacted in the user's absence. In some cases, responsibility is divided among people based on subject matter (e.g., adoption, ecosystem, line of business). Other messages have no substitute information. As shown, the subject line can include a description of the task (e.g., approve sales order x).

In practice, voice messages can also be mined using the techniques described herein.

As described herein, the text extracted from the out-of-office message can serve as raw data that is used to assemble features that are used for training and subsequent prediction.

### EXAMPLE 8—EXAMPLE SUBSTITUTE APPROVER

In any of the examples herein, a substitute approver (or simply “substitute”) can be a user who is suitable to participate in the automated process by making an approval decision for a task in the automated process. In practice, the substitute is represented internally as an identifier as described herein.

### EXAMPLE 9—EXAMPLE IDENTIFIERS

In any of the examples herein, an original approver, a substitute approver, or other user can be represented internally by a username, email address, or the like. Thus, a machine learning model can predict a substitute approver by outputting an identifier of the substitute.

### EXAMPLE 10—EXAMPLE AUTOMATED PROCESSES

In any of the examples herein, an automated process can take the form of an automated process that proceeds according to a pre-defined definition. An automated process is sometimes called an automated “workflow” (e.g., workflow instances with workflow metadata, etc.) The steps of the process are sometimes called “tasks.”

An example of such a process is related to a purchase requisition. Such a process can have an approval task that is applicable to the technologies described herein.

In practice, an automated process comprises a plurality of tasks that are typically executed in sequence. Parallel execution of tasks is possible, and some tasks may serve a prerequisite for others.

The internal representation of the automated process can include a representation of the tasks within the process, dependencies, database sources, permissions, and the like. A process can have an identifier (e.g., process definition identifier) to specify a name of the process, and plural instances of the same process name are possible (e.g., there are multiple instances created from the same process definition). The tasks within the process can have identifiers themselves (e.g., a task definition identifier).

Broader process types can be defined (e.g., finance, inventory, safety, and the like), and the internal representation can map processes to process type. Such types are sometimes called “process topic.”

In practice, an instance of the predefined automated process is created according to the process definition. Execution then begins. An approval may involve a document such as an invoice that is attached to an email or other message and sent to the primary approver, who is sometimes called the “original” approver herein. Such processes can extract information, send it for an approval, directly attach to a task and then send for approval, or the like. Besides approvals, processes can comprise other automated tasks. For example, automated decisions can be included. The process can define what to do when, decisions, forms, data types, and the like. Some tasks can be fully automated so that robots (e.g., an automated agent) takes steps (e.g., internally or via programmed sections that can open a screen and take actions as a person would).

Processes can be invoked by a trigger (e.g., a file is placed in a folder or the like). The file can be extracted, placed in a database or data structure, and then passed on for further tasks. If an approval task is included, then a message is sent to the user specified for the approval requesting approval. Then, upon approval or rejections, further execution can continue.

As described herein, if the user to whom the approval request is sent is absent (e.g., out of office), then someone else may need to step in as a substitute to keep the process execution moving forward.

In practice, automated processes can come from a variety of backend systems or task providers, including enterprise resource planning (ERP), finance, sales, or the like. Some processes can cross system boundaries; email can be used as a common area for seeking approvals and exchanging information about substitutes.

### EXAMPLE 11—EXAMPLE FEATURES

In any of the examples herein, a variety of features can be used as input to the machine learning model. Some features can be extracted from the out-of-office message; others can be taken from the automated process context or metadata (e.g., a name of the process, a name of the task, a process type, or the like).

In practice, a feature can be represented by a feature vector. For example, graphs can be converted to vectors using a node2vec technique or the like.

Due to the nature of machine learning, the trained model enables accurate predictions, even if only a few features are provided. For example, based on the identity of the original approver and the process type, an accurate prediction of a substitute approver can be made if historical data shows that only one substitute approver has ever served as substitute in such scenarios. On the other hand, additional features may help accuracy (e.g., the process definition identifier or the time of year may be a determinative factor in some cases).

Features can include entities (e.g., usernames) and their associated identifiers, organization (e.g., enterprise department or division), and relationships (e.g., whether served as the primary approver, substitute, or the like). Other features can include the process definition identifier, and an identifier of the task (e.g., approval step) in the process. The process topic can also be included as a feature. Additionally, metadata from the out-of-office message (e.g., time data such as date, month, quarter, etc.) can be used as described herein.

### EXAMPLE 12—EXAMPLE TRAINING DATA

In any of the examples herein, data can be assembled for training a machine learning model. As described herein, historical data such as historical out-of-office messages and historical substitute approver assignments can be used for training. For example, it can be helpful to look at prior executions of a process to find instances of when an out-of-office message was received, and which user actually served as a substitute approver in such instances. Thus, the machine learning model can be trained based on prior out-of-office messages and observed substitute approvers (e.g., prior electronic out-of-office messages and respective assigned substitute approvers).

The various techniques described herein such as named entity recognition, knowledge graph representation, and the like can be used to generate features used for training. When new cases are encountered, the same features can then be used for prediction.

Training can take place before deployment and continue afterwards as re-training using recent out-of-office messages (e.g., new messages received after an initial training and their respective assigned substitute approvers).

Although training can be performed in the same environment where it is used (e.g., for the same tenant or enterprise), such an approach typically takes some time before an acceptable accuracy is achieved. Thus, some implementations may wish to start sooner by using a pre-trained model.

### EXAMPLE 13—EXAMPLE CONSUMPTION FLOW

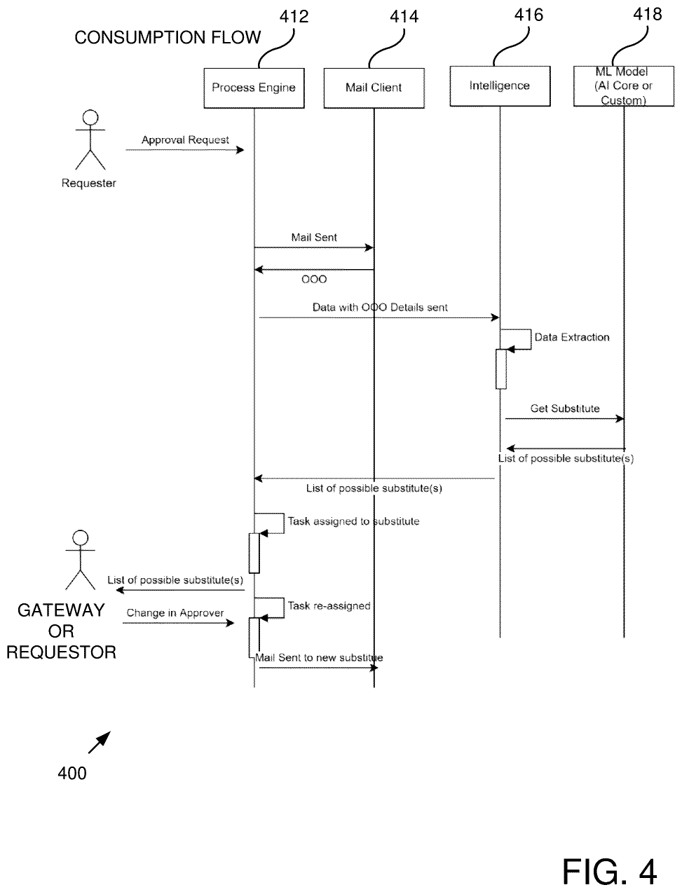

FIG. 4 sequence diagram of an example consumption flow 400 for intelligent substitution in process automation. As shown, a process engine 412, mail client 414, intelligence orchestrator 416, and a machine learning model 418 can work together to achieve intelligent substitution.

A requester sends an approval request to a process engine 412 in the ordinary course of automated process execution. In practice, some processes may be scheduled to automatically execute. As part of its execution of the process instance, the process engine may encounter an approval task and instruct a mail client 414 to send an email. However, an out-of-office message may be sent to the process engine 412 in response.

Upon detection of the out-of-office message, data about the automated process (e.g., process instance metadata) along with details (e.g., content and metadata) of the out-of-message message can be sent to the orchestrator 416 (e.g., an intelligence microservice).

The orchestrator 416 can extract information from the out-of-office message and request a substitute from the machine learning model 418, which responds with a list of one or more possible substitutes, which is then sent back to the process engine 412. A gateway or human requestor can be notified of the substitutes, who approves the change, resulting in a new email request (e.g., to the substitute approver) to the mail client 414. Other ways of processing the predicted substitutes can be implemented as described herein.

### EXAMPLE 14—EXAMPLE TRAINING FLOW

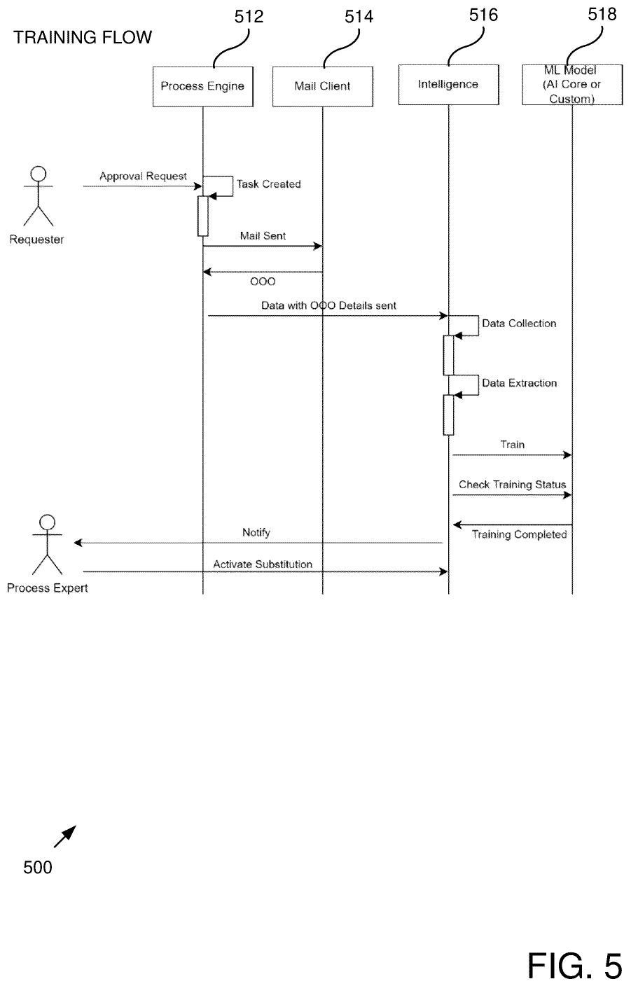

FIG. 5 sequence diagram showing an example training flow 500 for intelligent substitution in process automation. The process engine 512 can listen to out-of-office responses during execution of approval processes and collect such data for training. After sufficient data has been collected, continuous (e.g., on-the-fly) or periodic re-training can be used. During training and prediction, entities can be extracted, dependency trees can be created, and knowledge graphs prepared. A continual learning mechanism, along with enabling and disabling of intelligent substitution can be provided.

The training flow involves process engine 512, mail client 514, orchestrator 516 (e.g., an intelligence microservice), and machine learning model 518. Flow continues similar to that of the consumption flow, except that training is done, then training status is checked. Upon sufficient status (e.g., a threshold accuracy), training can be considered completed. A process expert can be notified, who then decides whether to activate substitution (e.g., the model is deployed). The process expert knows how the process works (e.g., what is permitted or desirable behavior) and can be a different person from the process administrator, who administers the process, even if the administrator does not know the details of how the process works.

Depending on the scenario, re-training can be performed continuously, or periodically to avoid an outdated model. For example, if someone leaves the organization, out-of-office messages will start showing a new name, and re-training can proceed using the new name.

### EXAMPLE 15—EXAMPLE ARCHITECTURE

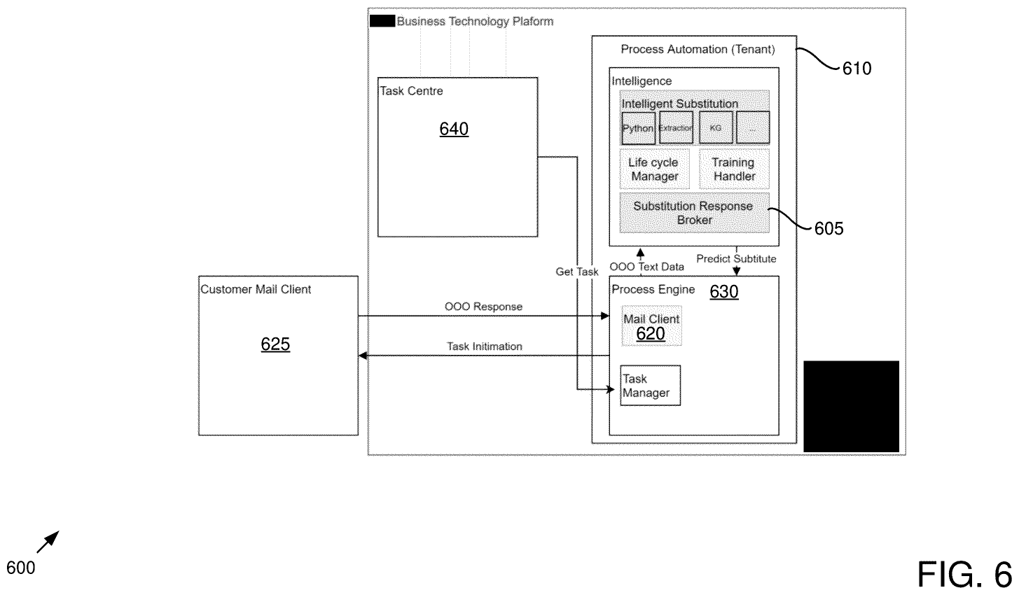

FIG. 6 is a block diagram of an example architecture 600 for implementing intelligent substitution in process automation. As shown, a substitution response broker 605 can orchestrate intelligence capability in a process automation system 610 (e.g., process intelligence in process management). Such a system 610 can analyze out-of-office responses received by the mail client 620 from the customer mail client 625 in a process engine 630 task center 640. The process instance identifier and approve step can be retrieved for later correlation.

The broker 605 can be responsible for the training and re-training of the machine learning model. It can analyze the out-of-office response that is received by the process engine 630. It can receive the process instance identifier and approval task identifier for correlation. A process definition can have its own identifier that can be determined from the process instance identifier. Thus, a correlation between the process instance identifier and the proposed substitute approver can be tracked for determining various features for training, validation, and the like.

At the time of onboarding, the enterprise can choose to enable intelligent substitution. It can be enabled immediately or later through a user interface. The user interface can provide an option to start training and activate the model based on specified criteria. The active model can then automatically start proposing substitutes.

### EXAMPLE 16—EXAMPLE INTEGRATION

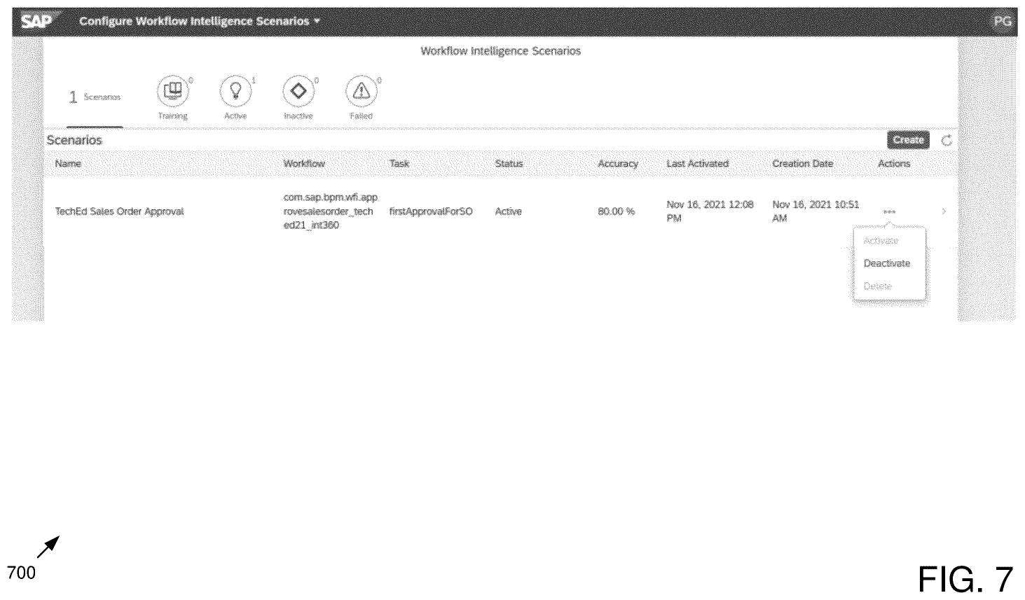

FIG. 7 is an example user interface 700 for implementing intelligent substitution in process automation. In the example, a representation of an approval scenario is displayed, and the user can select whether to activate, deactivate, or delete the scenario. New scenarios can be created.

The level of granularity can be at the individual process (e.g., process definition identifier) level by specifying the name of the process. Thus, one process may use intelligent substitution while another does not.

The accuracy of the predicted substitutes can be displayed for reference when deciding whether to activate the scenario.

Thus, a user interface can be presented for activating machine-learning-based approver substitution for automated processes.

### EXAMPLE 17—EXAMPLE INTEGRATION

Intelligent substitution can be implemented in a process automation system (e.g., automated process system). A Python environment (or connection to AI foundation), entity extractor, and knowledge graph can interact with a substitution response broker as described herein.

An entity extractor can be implemented in a variety of ways. For example, a Business Entity Recognition (BER) service can be used; it is a platform service of AI foundation. The model can be trained and hosted on AI foundation through a Named Entity Recognition (NER) approach based on natural language processing. For example, the Bidirectional Encoder Representations from Transformers (BERT) can be used as a core extraction mechanism.

For example, named entity recognition (NER) can be applied to text of the electronic out-of-office message, and entities extracted therefrom for inclusion in a knowledge graph.

Entity extraction may not be sufficient when an entity spans across multiple words (e.g., “teen chess prodigy”), so a dependency tree of the sentences can be generated.

To find relationships between entities, a knowledge graph can be generated using production data continuously (e.g., on the fly) at the time of training. To generate the knowledge graph, the process automation system can rely on the mail client to intercept the out-of-office response. After the response is intercepted, a knowledge graph can be generated using the data in the out-of-office response. For example, named entity recognition can be applied to the text of the electronic out-of-office message. Nodes and relationship information can be derived from the out-of-office response.

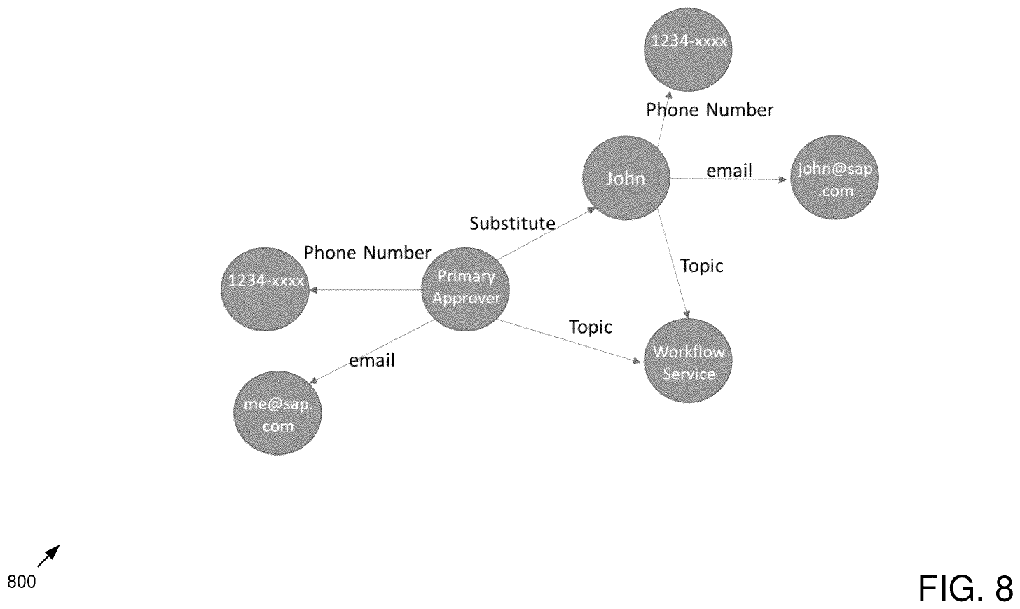

FIG. 8 is a block diagram of an example knowledge graph 800 representation of an out-of-office message. In the example, the text “Get in touch with John for any topic related to Process Service in my absence” is represented. Construction of the graph can draw from systems that have information about identifiers, relationships, alternate names, and the like.

A substitution response broker can notify a process administrator to assign the proposed substitutes or assigns the substitute's list (or individual name) to the approval task if the tenant's policies allow automatic assignment of approvers.

### EXAMPLE 18—EXAMPLE FEATURE ASSEMBLY

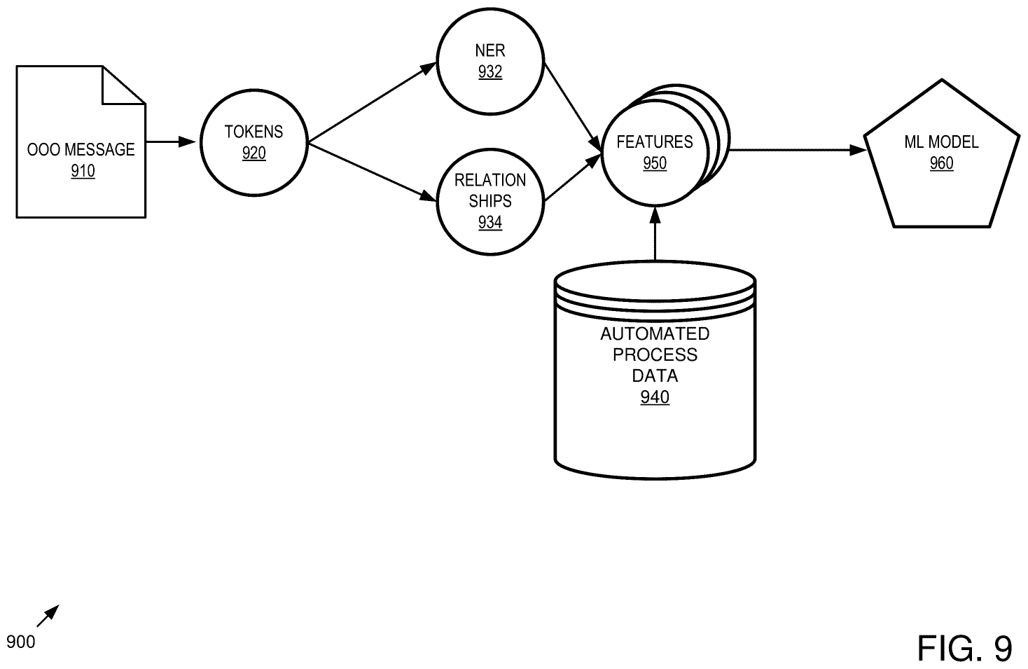

FIG. 9 is a block diagram of an example system 900 assembling features for a machine learning model. As shown, the out-of-office message 910 can be used to generate tokens 920 that are then extracted as named entities 932, and relationships 934 can be determined. The information is used to assemble features 950. Additional features can be obtained from the automated process data 940. For example, automated process instance metadata (e.g., the requester, the original substitute, the process definition identifier, the approval task identifier, process topic, or the like) can also be incorporated as features. Then, the machine learning model 960 can be trained with the features 950. In practice, a knowledge graph and related embeddings can be used for training.

The features shown can be used for training and subsequent prediction.

### EXAMPLE 19—EXAMPLE FEATURE EXTRACTION

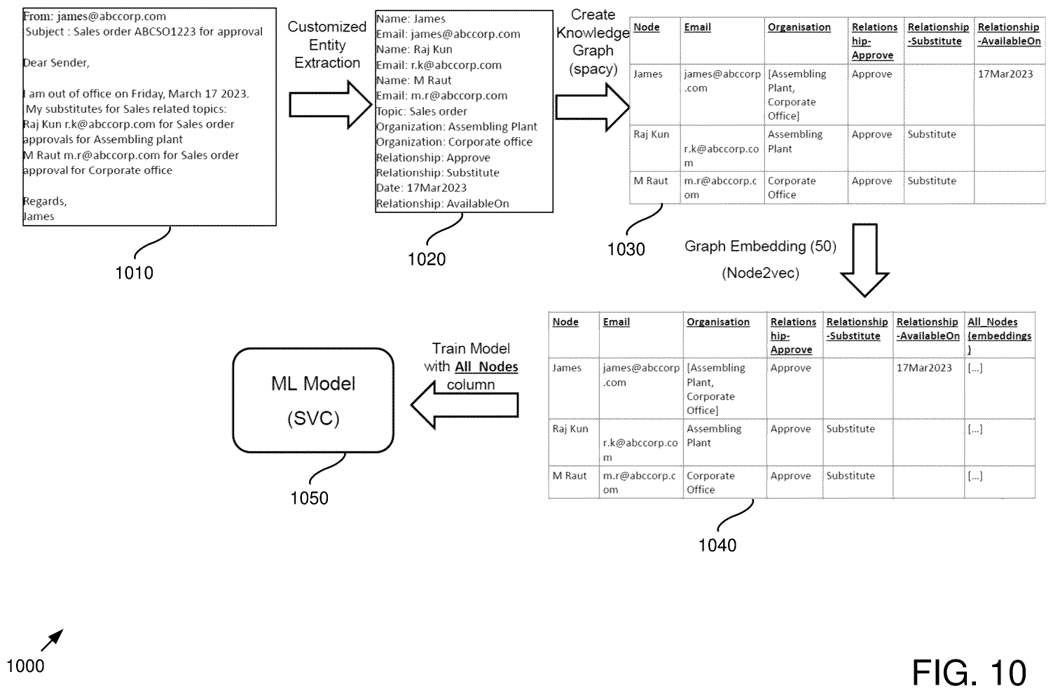

FIG. 10 is a block diagram of example feature extraction 1000 from an out-of-office message for a machine learning model and shows an overview of the extraction process. In the example, the extraction uses the raw data of the out-of-office message 1010. Customized entity extraction is applied to extract entities 1020 represented as entity type/entity value pairs. A knowledge graph 1030 can be created as a data frame with rows for entities and columns for attributes of the entities. The data frame can be used to represent knowledge. For example, the spaCy tool can be used. Graph embeddings can be added to generate the knowledge graph with embeddings 1040. For example, node2vec can be used to generate the embeddings. The embeddings of the knowledge graph with embeddings 1040 can then be used to train the model 1050 (e.g., with the all_nodes column).

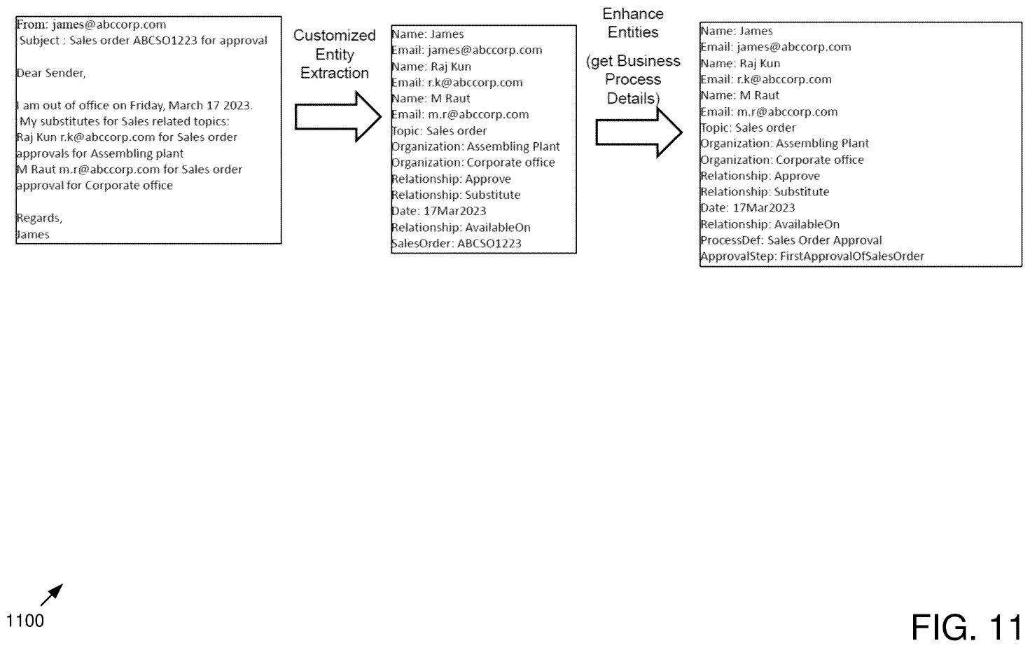

FIGS. 11, 12, and 13 are block diagrams of example details 1100, 1200, and 1300 of conversion from an out-of-office message to features for training a machine learning model. FIG. 11 shows customized entity extraction. The entities are enhanced. Enhancement can comprise obtaining process instance metadata (e.g., information from the process automation system comprising a process definition identifier (“ProcessDef”) and the approval step within the process definition). Such information can serve as helpful additional features for the machine learning model. For example, a different substitute may be predicted based on input of a different process definition identifier.

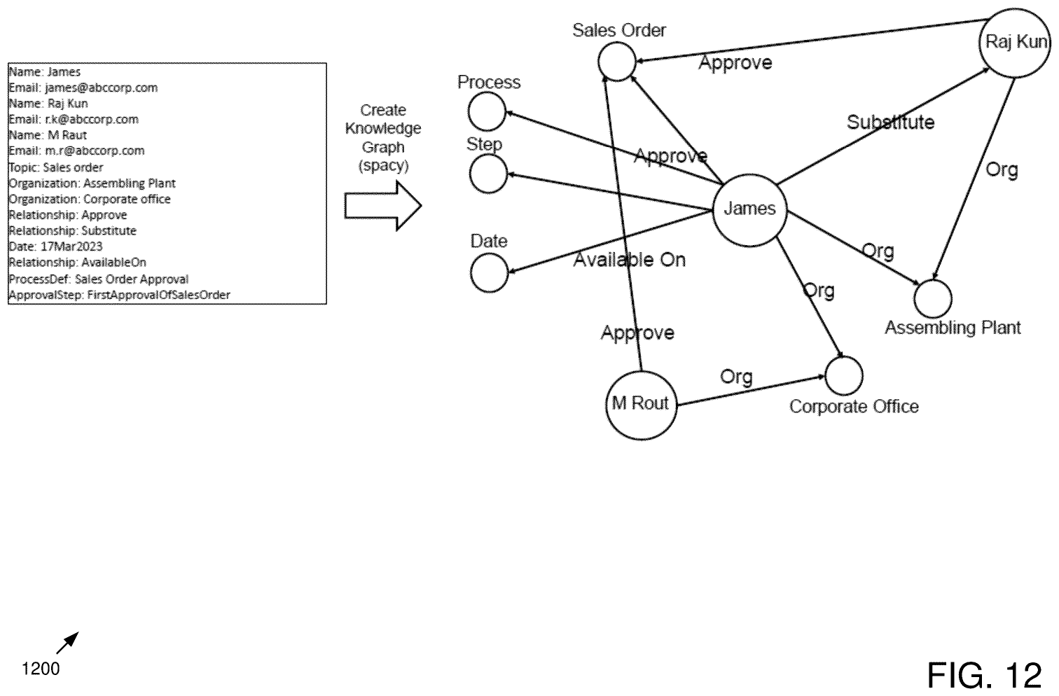

FIG. 12 shows conversion from entities to a knowledge graph. The knowledge graph can be customized per tenant. Tenant data can be maintained confidential. Nodes with contact details such as email can be created as well.

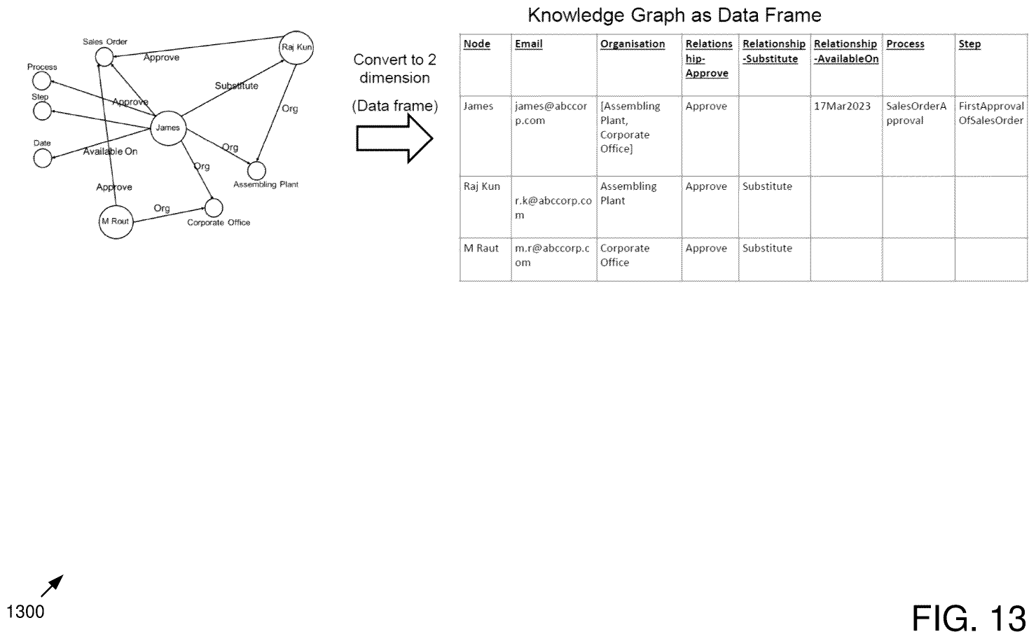

FIG. 13 shows conversion from a knowledge graph to a data frame with one row per entity. An additional column can be added to store embeddings of the knowledge graph so that the entire knowledge graph can be preserved for training. The embeddings (e.g., of the knowledge graph) can then be used for machine learning model training (e.g., with the all_nodes column).

The graph representation can be converted into a vector representation, and the original approver can be incorporated into the vector representation. The vector representation can be used for training and prediction.

### EXAMPLE 20—ADDITIONAL DETAILS

A manually-configured rule-based approach has numerous drawbacks, including synchronization issues, the complexity of rules, cache issues, and the like.

### EXAMPLE 21—EXAMPLE IMPLEMENTATIONS

Any of the following can be implemented.

Clause 1. A computer-implemented method comprising:
during execution of an automated process instance specifying an original approver for a task in the automated process instance, receiving an electronic out-of-office message of the original approver;
extracting features from the electronic out-of-office message;
sending features comprising the extracted features and metadata of the automated process instance comprising an identifier of the original approver to a machine learning model trained to predict a substitute approver for the original approver;
with the machine learning model, based on the features comprising the extracted features and the metadata of the automated process instance, predicting a substitute approver for the original approver; and
receiving, from the machine learning model, an identifier of the substitute approver.

Clause 2. The computer-implemented method of Clause 1, further comprising:
sending a message to the substitute approver seeking approval of the task in the automated process instance.

Clause 3. The computer-implemented method of any one of Clauses 1-2, further comprising:
sending a message to an administrator indicating that the substitute approver has been determined and that a seeking-approval message is to be sent to the substitute approver seeking approval of the task in the automated process instance.

Clause 4. The computer-implemented method of any one of Clauses 1-3, further comprising:
determining an automated process definition identifier of the automated process instance;
wherein:
the machine learning model predicts the substitute approver based on the automated process definition identifier.

Clause 5. The computer-implemented method of any one of Clauses 1-4, further comprising:
determining a task definition identifier of the automated process instance, wherein the task definition identifier identifies a task for seeking approval from the original approver;
wherein:
the features comprise the task definition identifier; and
the machine learning model predicts the substitute approver based on the task definition identifier.

Clause 6. The computer-implemented method of any one of Clauses 1-5, further comprising:
determining whether the substitute approver has permissions to approve the task in the automated process instance.

Clause 7. The computer-implemented method of any one of Clauses 1-6, wherein:
extracting features from the electronic out-of-office message comprises applying named entity recognition (NER) to text of the electronic out-of-office message.

Clause 8. The computer-implemented method of any one of Clauses 1-7, further comprising:
building a knowledge graph with named entities recognized in the text of the electronic out-of-office message.

Clause 9. The computer-implemented method of any one of Clause 8, further comprising:
building an embedding based on the knowledge graph; and
including the embedding as a feature.

Clause 10. The computer-implemented method of any one of Clauses 1-9, further comprising:
updating a process system to reflect that the substitute approver can approve the task in the automated process instance.

Clause 11. The computer-implemented method of any one of Clauses 1-10, wherein:
the machine learning model is activated responsive to determining that accuracy of the machine learning model has exceeded a specified threshold.

Clause 12. The computer-implemented method of any one of Clauses 1-11, wherein:
the machine learning model is trained based on prior electronic out-of-office messages and respective assigned substitute approvers.

Clause 13. The computer-implemented method of any one of Clauses 1-12, further comprising:
retraining the machine learning model based on recent electronic out-of-office messages.

Clause 14. The computer-implemented method of any one of Clauses 1-13, wherein:
extracting features from the electronic out-of-office message comprises:
generating a graph representation of the electronic out-of-office message; and
generating an embedding of the graph representation.

Clause 15. The computer-implemented method of any one of Clauses 1-14, wherein:
extracting features from the electronic out-of-office message comprises:
extracting text from the electronic out-of-office message;
generating a graph representation of the extracted text; and
converting the graph representation into a vector representation;
incorporating the original approver into the vector representation;
wherein, the machine learning model predicts a substitute approver for the original approver based on the vector representation.

Clause 16. A computing system comprising:
at least one hardware processor;
at least one memory coupled to the at least one hardware processor;
stored internal representations of plurality of automated processes comprising a plurality of tasks;
a machine learning model trained with substitute approvers observed as assigned as substitute approvers for original approvers of the automated processes and configured to predict one or more substitute approvers for an original approver; and
one or more non-transitory computer-readable media having stored therein computer-executable instructions that, when executed by the computing system, cause the computing system to perform:
during execution of a given automated process instance specifying an original approver for a task in the given automated process instance, receiving an electronic out-of-office message of the original approver;
extracting features from text of the electronic out-of-office message;
sending the extracted features and an identifier of the original approver to the machine learning model;
with the machine learning model, based on the extracted features and the identifier of the original approver, predicting a substitute approver for the original approver; and
receiving, from the machine learning model, an identifier of the predicted substitute approver.

Clause 17. The computing system of Clause 16, wherein the computer-executable instructions further comprise computer-executable instructions that, when executed by the computing system, cause the computing system to perform:
presenting a user interface for activating machine-learning-based approver substitution for automated processes.

Clause 18. The computing system of any one of Clauses 16-17, wherein:
extracting features comprises applying named entity recognition (NER) to the text of the electronic out-of-office message, finding attributes for named entities, and building a knowledge graph of the named entities and attributes.

Clause 19. The computing system of any one of Clauses 16-18, wherein:
extracting features comprises building a knowledge graph of named entities identified in the electronic out-of-office message.

Clause 20. One or more non-transitory computer-readable media comprising computer-executable instructions that, when executed by a computing system, cause the computing system to perform operations comprising:
during execution of an automated process instance specifying an original approver for a step in the automated process instance, receiving an electronic out-of-office message of the original approver;
extracting text from the electronic out-of-office-message;
with the extracted text, generating a representation of a plurality of extracted features;
sending the representation of the plurality of extracted features and metadata of the automated process instance comprising an identifier of the original approver to a machine learning model trained to predict a substitute approver for the original approver;
with the machine learning model, predicting a substitute approver for the original approver;
receiving, from the machine learning model, an identifier of the substitute approver;
for the step in the automated process instance, redirecting an original request for approval to an identifier of the substitute approver.

Clause 21. One or more non-transitory computer-readable media comprising computer-executable instructions that, when executed by a computing system, cause the computing system to perform the method of any one of Clauses 1-15.

Clause 22. A computing system comprising:
at least one hardware processor; and
at least one memory coupled to the at least one hardware processor;
wherein the memory stores computer-executable instructions that, when executed by the computing system, cause the computing system to perform the method of any one of Clauses 1-15

### EXAMPLE 22—EXAMPLE ADVANTAGES

A number of advantages can be achieved via the technologies described herein. Some of the advantages stem from the fact that users, the IT department, or developers no longer need to maintain a separate set of rules for approvals.

The technologies can avoid business disruption or delays with automatic substitution proposal. No explicit data is required for training the intelligent substitution. The user need not have any machine learning knowledge to implement the described solution.

The technologies can provide substitution assignments on the fly (e.g., in real time in response to an electronic out-of-office message). The technologies reduce the efforts to maintain substitutes (e.g., substitution rules need not be turned on/off, and there is no maintenance of planned/unplanned rules). The solution has the potential to reduce the investment to build a complete feature for substitution in a task center.

The technologies can both save storage space (e.g., because explicit rules need not be stored and maintained) and increase performance (e.g., because processes are completed more quickly).

Further, because email can be used as a common area for sharing information, the system need not be duplicated across different backend task providers (e.g., finance, ERP, HR, and the like). Thus, a single point of sharing can be supported.

### EXAMPLE 23—EXAMPLE COMPUTING SYSTEMS

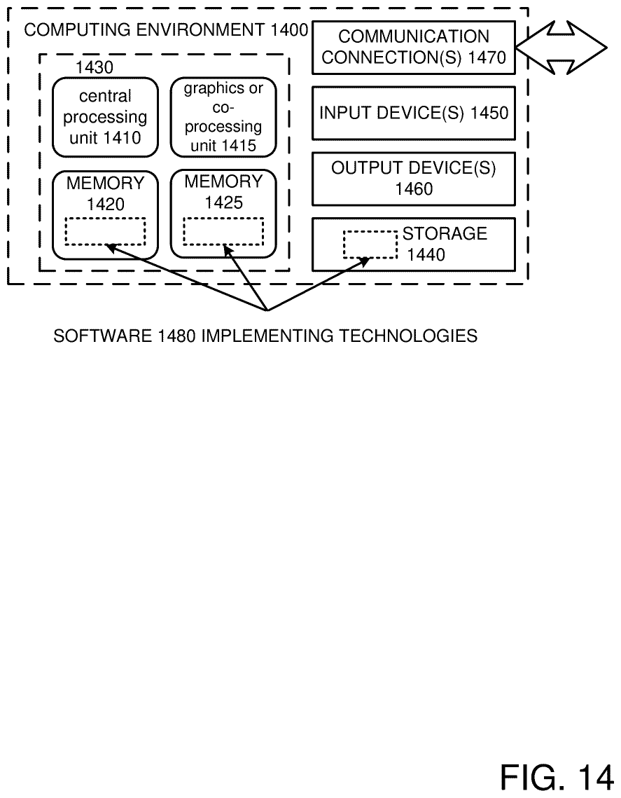

FIG. 14 depicts an example of a suitable computing system 1400 in which the described innovations can be implemented. The computing system 1400 is not intended to suggest any limitation as to scope of use or functionality of the present disclosure, as the innovations can be implemented in diverse computing systems.

With reference to FIG. 14, the computing system 1400 includes one or more processing units 1410, 1415 and memory 1420, 1425. In FIG. 14, this basic configuration 1430 is included within a dashed line. The processing units 1410, 1415 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 14 shows a central processing unit 1410 as well as a graphics processing unit or co-processing unit 1415. The tangible memory 1420, 1425 can be volatile memory (e.g., registers, cache, RAM), non-volatile memory (e.g., ROM, EEPROM, flash memory, etc.), or some combination of the two, accessible by the processing unit(s) 1410, 1415. The memory 1420, 1425 stores software 1480 implementing one or more innovations described herein, in the form of computer-executable instructions suitable for execution by the processing unit(s) 1410, 1415.

A computing system 1400 can have additional features. For example, the computing system 1400 includes storage 1440, one or more input devices 1450, one or more output devices 1460, and one or more communication connections 1470, including input devices, output devices, and communication connections for interacting with a user. An interconnection mechanism (not shown) such as a bus, controller, or network interconnects the components of the computing system 1400. Typically, operating system software (not shown) provides an operating environment for other software executing in the computing system 1400, and coordinates activities of the components of the computing system 1400.

The tangible storage 1440 can be removable or non-removable, and includes magnetic disks, magnetic tapes or cassettes, CD-ROMs, DVDs, or any other medium which can be used to store information in a non-transitory way and which can be accessed within the computing system 1400. The storage 1440 stores instructions for the software 1480 implementing one or more innovations described herein.

The input device(s) 1450 can be an input device such as a keyboard, mouse, pen, or trackball, a voice input device, a scanning device, touch device (e.g., touchpad, display, or the like) or another device that provides input to the computing system 1400. The output device(s) 1460 can be a display, printer, speaker, CD-writer, or another device that provides output from the computing system 1400.

The communication connection(s) 1470 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### EXAMPLE 24—COMPUTER-READABLE MEDIA

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### EXAMPLE 25—EXAMPLE CLOUD COMPUTING ENVIRONMENT

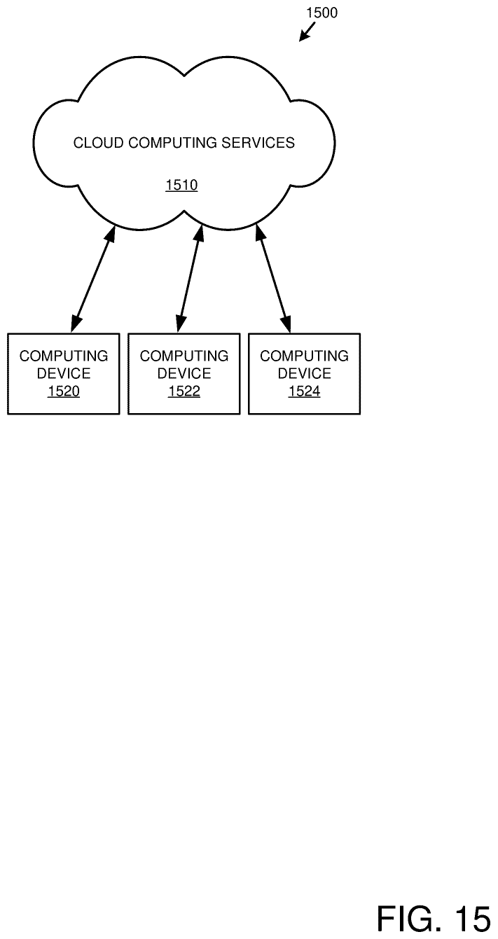

FIG. 15 depicts an example cloud computing environment 1500 in which the described technologies can be implemented, including, e.g., the system 100 of FIG. 1 and other systems herein. The cloud computing environment 1500 comprises cloud computing services 1510. The cloud computing services 1510 can comprise various types of cloud computing resources, such as computer servers, data storage repositories, networking resources, etc. The cloud computing services 1510 can be centrally located (e.g., provided by a data center of a business or organization) or distributed (e.g., provided by various computing resources located at different locations, such as different data centers and/or located in different cities or countries).

The cloud computing services 1510 are utilized by various types of computing devices (e.g., client computing devices), such as computing devices 1520, 1522, and 1524. For example, the computing devices (e.g., 1520, 1522, and 1524) can be computers (e.g., desktop or laptop computers), mobile devices (e.g., tablet computers or smart phones), or other types of computing devices. For example, the computing devices (e.g., 1520, 1522, and 1524) can utilize the cloud computing services 1510 to perform computing operations (e.g., data processing, data storage, and the like).

In practice, cloud-based, on-premises-based, or hybrid scenarios can be supported.

### EXAMPLE 26—EXAMPLE IMPLEMENTATIONS

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### EXAMPLE 27—EXAMPLE ALTERNATIVES

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
during execution of an automated process instance specifying an original approver for a task in the automated process instance, receiving an electronic out-of-office message of the original approver;
extracting features from the electronic out-of-office message;
sending features comprising the extracted features and metadata of the automated process instance comprising an identifier of the original approver to a machine learning model trained to predict a substitute approver for the original approver;
with the machine learning model, based on the features comprising the extracted features and the metadata of the automated process instance, predicting a substitute approver for the original approver; and
receiving, from the machine learning model, an identifier of the substitute approver.

2. The computer-implemented method of claim 1, further comprising:
sending a message to the substitute approver seeking approval of the task in the automated process instance.

3. The computer-implemented method of claim 1, further comprising:
sending a message to an administrator indicating that the substitute approver has been determined and that a seeking-approval message is to be sent to the substitute approver seeking approval of the task in the automated process instance.

4. The computer-implemented method of claim 1, further comprising:
determining an automated process definition identifier of the automated process instance;
wherein:
the machine learning model predicts the substitute approver based on the automated process definition identifier.

5. The computer-implemented method of claim 1, further comprising:
determining a task definition identifier of the automated process instance, wherein the task definition identifier identifies a task for seeking approval from the original approver;
wherein:
the features comprise the task definition identifier; and
the machine learning model predicts the substitute approver based on the task definition identifier.

6. The computer-implemented method of claim 1, further comprising:
determining whether the substitute approver has permissions to approve the task in the automated process instance.

7. The computer-implemented method of claim 1, wherein:
extracting features from the electronic out-of-office message comprises applying named entity recognition (NER) to text of the electronic out-of-office message.

8. The computer-implemented method of claim 7, further comprising:
building a knowledge graph with named entities recognized in the text of the electronic out-of-office message.

9. The computer-implemented method of claim 8, further comprising:
building an embedding based on the knowledge graph; and
including the embedding as a feature.

10. The computer-implemented method of claim 1, further comprising:
updating a process system to reflect that the substitute approver can approve the task in the automated process instance.

11. The computer-implemented method of claim 1, wherein:
the machine learning model is activated responsive to determining that accuracy of the machine learning model has exceeded a specified threshold.

12. The computer-implemented method of claim 1, wherein:
the machine learning model is trained based on prior electronic out-of-office messages and respective assigned substitute approvers.

13. The computer-implemented method of claim 1, further comprising:
retraining the machine learning model based on recent electronic out-of-office messages.

14. The computer-implemented method of claim 1, wherein:
extracting features from the electronic out-of-office message comprises:
generating a graph representation of the electronic out-of-office message; and
generating an embedding of the graph representation.

15. The computer-implemented method of claim 1, wherein:
extracting features from the electronic out-of-office message comprises:
extracting text from the electronic out-of-office message;
generating a graph representation of the extracted text; and
converting the graph representation into a vector representation;
incorporating the original approver into the vector representation;
wherein, the machine learning model predicts the substitute approver for the original approver based on the vector representation.

16. A computing system comprising:
at least one hardware processor;
at least one memory coupled to the at least one hardware processor;
stored internal representations of plurality of automated processes comprising a plurality of tasks;
a machine learning model trained with substitute approvers observed as assigned as substitute approvers for original approvers of the automated processes and configured to predict one or more substitute approvers for an original approver; and
one or more non-transitory computer-readable media having stored therein computer-executable instructions that, when executed by the computing system, cause the computing system to perform:
during execution of a given automated process instance specifying an original approver for a task in the given automated process instance, receiving an electronic out-of-office message of the original approver;
extracting features from text of the electronic out-of-office message;
sending the extracted features and an identifier of the original approver to the machine learning model;
with the machine learning model, based on the extracted features and the identifier of the original approver, predicting a substitute approver for the original approver; and
receiving, from the machine learning model, an identifier of the predicted substitute approver.

17. The computing system of claim 16, wherein the computer-executable instructions further comprise computer-executable instructions that, when executed by the computing system, cause the computing system to perform:
presenting a user interface for activating machine-learning-based approver substitution for automated processes.

18. The computing system of claim 16, wherein:
extracting features comprises applying named entity recognition (NER) to the text of the electronic out-of-office message, finding attributes for named entities, and building a knowledge graph of the named entities and attributes.

19. The computing system of claim 16, wherein:
extracting features comprises building a knowledge graph of named entities identified in the electronic out-of-office message.

20. One or more non-transitory computer-readable media comprising computer-executable instructions that, when executed by a computing system, cause the computing system to perform operations comprising:
during execution of an automated process instance specifying an original approver for a step in the automated process instance, receiving an electronic out-of-office message of the original approver;
extracting text from the electronic out-of-office-message;
with the extracted text, generating a representation of a plurality of extracted features;
sending the representation of the plurality of extracted features and metadata of the automated process instance comprising an identifier of the original approver to a machine learning model trained to predict a substitute approver for the original approver;
with the machine learning model, predicting a substitute approver for the original approver;
receiving, from the machine learning model, an identifier of the substitute approver;
for the step in the automated process instance, redirecting an original request for approval to an identifier of the substitute approver.
